(19) United States
(12) Patent Application Publication
(10) Pub. No.: US 2017/0139899 A1
(43) Pub. Date: May 18, 2017

(54) KEYWORD EXTRACTION METHOD AND ELECTRONIC DEVICE

(71) Applicants: Le Holdings (Beijing) Co., Ltd., Beijing (CN); Le Shi Internet Information Technology Corp. Beijing, Beijing (CN)

(72) Inventor: Jiulong Zhao, Beijing (CN)

(21) Appl. No.: 15/241,121

(22) Filed: Aug. 19, 2016

Related U.S. Application Data
(63) Continuation of application No. PCT/CN2016/082642, filed on May 19, 2016.

(30) Foreign Application Priority Data
Nov. 18, 2015 (CN) 201510799348.6

(51) Int. Cl. G06F 17/27

(52) U.S. Cl. CPC G06F 17/277; G06F 17/2785

(57) ABSTRACT

The embodiments of the present disclosure provide a keyword extraction method and device. Using a segmenter to segment a text to acquire words, and filtering the words to acquire candidate keywords; calculating the similarity between any two of the candidate keywords; calculating the weights of the candidate keywords according to the similarity, and calculating the inverse document frequencies of the candidate keywords according to a preset corpus; and acquiring the criticality of the candidate keywords according to the weights and the inverse document frequencies of the candidate keywords, and selecting keywords according to the criticality of the candidate keywords. The present disclosure improves the keyword extraction accuracy.

### CROSS-REFERENCE TO RELATED APPLICATION

This application is a continuation of International Application No. PCT/CN2016/082642, filed May 19, 2016, which is based upon and claims priority to Chinese Patent Application No. 201510799348.6, filed Nov. 18, 2015, the entire contents of all of which are incorporated herein by reference.

### FIELD OF TECHNOLOGY

The embodiments of the present disclosure relate to the field of information technologies, and, more particularly, to a keyword extraction method and an electronic device.

### BACKGROUND

With the continuous development of information technologies, a large number of text starts existing in a computer-readable form, and information presents an explosive growth in multiple fields, such as film reviews and short reviews on Douban. How to quickly and accurately extract useful information in the mass of information will be an important technical demand. Keyword extraction is just an effective way to solve the foregoing problems. The keyword is the essence of the main information of an article, grasping important information quickly and improving the information access efficiency.

There are two keyword extraction methods generally: the first one is a keyword distribution, i.e., a keyword database is given, and then several words of an article are found from the database as the keywords of the article. The other one is a keyword extraction, i.e., some words are extracted from an article as the keywords of this article. At present, most domain-independent keyword extraction algorithms (the meaning of the domain-independent algorithm is an algorithm capable of extracting keywords from texts in any subject or domain) and a corresponding database thereof is based on the keyword extraction. Compared with the keyword distribution, the keyword extraction is more practical.

The keyword extraction algorithms mainly include a TF-IDF algorithm, a KEA algorithm and a TextRank algorithm currently. The TF-IDF keyword extraction algorithm introduced in “The Beauty of Mathematics” needs to pre-save the IDF (Inverse Document Frequency) value of each word as an external knowledge base, while a complex algorithm needs to save more information. The algorithm not using an external knowledge base can mainly implement language-independence and avoid problems caused by words not existing in the vocabulary. The thought of the TF-IDF algorithm is to find words frequent in a text but infrequent in other texts, and this fits well with the keyword features.

An initial generation KEA algorithm also uses the position of the words firstly appeared in the article excluding TF-IDF, which is based on that most articles (especially news text) are in a total structure. It is apparently that the probability of a word appearing in the head and tail of the article as the keywords is greater than that of a word only appearing in the middle of the article. The core concept of the initial generation KEA algorithm is to give different weights for each word according to the position firstly appeared in the article, and combine with the TF-IDF algorithm and a continuous data discretization method.

The keyword algorithm not dependent on the external knowledge base mainly extracts the keywords according to the features of the text itself. For example, one feature of the keywords is that the probability of the keyword repeatedly appearing in the text and keywords appearing near keywords is very large, so there is the TextRank algorithm. It uses a similar PageRank algorithm, sees each word in the text as a page, and considers that a certain word in the text has a link with N words surrounding the word, and then uses PageRank to calculate the weight of each word in this network, and several words with the highest weights are served as the keywords. Typical implementations of Textrank include FudanNLP, SnowNLP, or the like.

The similarity of the words is considered in none of the above algorithms. TF*IDF measures the importance of the word based on the product of term frequency (TF) and inverse document frequency (IDF). The advantages of the algorithm are simple and quick; while the defects thereof are also very apparent. Simply calculating the “Term Frequency” is not comprehensive enough, and cannot reflect the position information of the word. A positional relationship is calculated in TextRank, while which word in this position is not considered, and the similarity of words influences the results. Therefore, it is highly desirable to propose an effective and accurate keyword extraction algorithm.

### SUMMARY

The embodiments of the present disclosure provide a keyword extraction algorithm and a keyword extraction device, for solving the defects that the prior art only considers the term frequency and the positional relationship of words, and improving the keyword extraction accuracy.

The embodiments of the present disclosure provide a keyword extraction method, including:

using a segmenter to segment a text to acquire words, and filtering the words to acquire candidate keywords;

calculating the similarity between any two of the candidate keywords;

calculating the weight of each of the candidate keywords according to the similarity, and calculating inverse document frequencies of the candidate keywords according to a preset corpus; and

acquiring the criticality of the candidate keywords according to the weights and the inverse document frequencies of the candidate keywords, and selecting keywords according to the criticality of the candidate keywords.

The embodiments of the present disclosure provide an electronic device, including:

a processor; and

a memory for storing instructions executable by the processor;

wherein the processor is configured to:

use a segmenter to segment a text to acquire words, and filter the words to acquire candidate keywords;

calculate the similarity between any two of the candidate keywords;

calculate the weights of the candidate keywords according to the similarity, and calculate the inverse document frequencies of the candidate keywords according to a preset corpus; and

acquire the criticality of the candidate keywords according to the weights and the inverse document frequencies of the candidate keywords, and select keywords according to the criticality of the candidate keywords.

The embodiments of the present disclosure a non-transitory computer-readable storage medium having stored therein instructions that, when executed by one or more processors of an electronic device, cause the electronic device to perform operations including:

using a segmenter to segment a text to acquire words, and filtering the words to acquire candidate keywords;

calculating the similarity between any two of the candidate keywords;

calculating the weights of the candidate keywords according to the similarity, and calculating the inverse document frequencies of the candidate keywords according to a preset corpus; and

acquiring the criticality of the candidate keywords according to the weights and the inverse document frequencies of the candidate keywords, and selecting keywords according to the criticality of the candidate keywords.

It is to be understood that both the foregoing general description and the following detailed description are exemplary and explanatory only and are not restrictive of the present disclosure, as claimed.

### BRIEF DESCRIPTION OF THE DRAWINGS

The drawings illustrated herein are intended to provide further understanding of the present disclosure, constituting a part of the present application. Exemplary embodiments and explanations of the present disclosure here are only for explanation of the present disclosure, but are not intended to limit the present disclosure. In the drawings:

FIG. 1 is a technical flow chart of a first embodiment of the present disclosure;

FIG. 2 is a technical flow chart of a second embodiment of the present disclosure;

FIG. 3 is a structural diagram of a device of a third embodiment of the present disclosure;

FIG. 4 is an example of a lexical item pattern of an application example according to the present disclosure;

FIG. 5 is an example of the lexical item pattern of the application example after TextRank iteration according to the present disclosure; and

FIG. 6 is a structural diagram of an electronic device according to the present disclosure.

### DETAILED DESCRIPTION

To make the objects, technical solutions and advantages of the embodiments of the present disclosure more clearly, the technical solutions of the present disclosure will be clearly and completely described hereinafter with reference to the embodiments and drawings of the present disclosure. Apparently, the embodiments described are merely partial embodiments of the present disclosure, rather than all embodiments. Other embodiments derived by those having ordinary skills in the art on the basis of the embodiments of the disclosure without going through creative efforts shall all fall within the protection scope of the present disclosure.

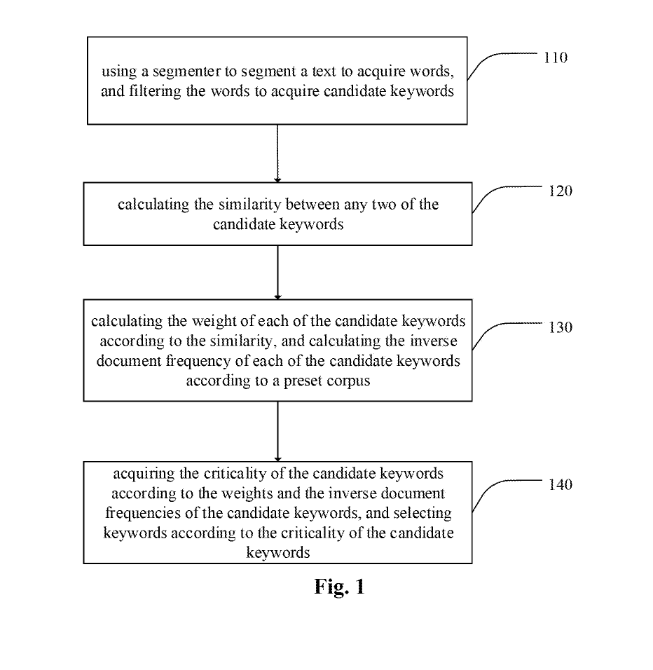

FIG. 1 is a technical flow chart of the first embodiment of the present disclosure. With reference to FIG. 1, the keyword extraction method according to the embodiment of the present disclosure mainly includes the following steps.

In step 110: a segmenter is used to segment a text to acquire words, and the words are filtered to acquire candidate keywords.

In the embodiment of the present disclosure, the present segmenter is used to segment the collected text into individual words and acquire the part of speech of each word, wherein the segmenter may include a segmenter based on a dictionary matching algorithm, a segmenter based on lexicon matching, a segmenter based on word frequency statistics and a segmenter based on knowledge understanding, or the like, and will not be limited by the embodiment of the present disclosure.

The words need a further processed after being acquired by the segmenter, for example, stop words and unessential words are filtered for the words according to the part of speech and a preset blacklist. The stop words are some words without practical meanings, including modal particles, adverbs, prepositions, conjunctions, or the like. The stop words do not have definite meanings usually and have a certain effect only in a complete sentence, such as those words like “of, and in” common in a Chinese text, and “the, is, at, which, on” in an English text. Some unessential words may be filtered according to the preset blacklist and with reference to a regex expression, to obtain the candidate keywords in the text.

In step 120: the similarity between any two of the candidate keywords is calculated.

In the embodiment of the present disclosure, word2vec is used to calculate word vectors. word2vec is a tool that converts the words into a vector form, which may simplify the processing of the contents of the text into a vector operation in a vector space, to calculate the simplify in the vector space to represent the semantic similarity of the text.

word2vec provides an effective continuous bag-of-words (bag-of-words) and a skip-grain architecture for calculating the vector words. Word2vec may calculate the distance between words, and may cluster the words after knowing the distance. Moreover, word2vec itself also provides a clustering function. A deep learning technology is used, which not only has a very high accuracy, but also has a very high efficiency, and is suitable for processing mass data.

In step 130: the weight of each of the candidate keywords is calculated according to the similarity, and the inverse document frequency of each of the candidate keywords is calculated according to a preset corpus.

In the embodiment of the present disclosure, a TextRank formula is used to iteratively calculate the weight of each of the candidate keywords, and lexical item patterns G(V, E) are pre-established before the iterative calculation, wherein V is a set of the candidate keywords, E is the sum of a set of edges formed by connecting any two candidate keywords, and E⊂V×V.

A following formula is used to iteratively calculate the weight of each of the candidate keywords according to preset iteration times:

$$WS ( {V}_{i} ) = ( 1 - d ) + d * {\sum }_{{V}_{j} ∈ In ( {V}_{i} )} \frac{{w}_{ji}}{{\sum }_{{v}_{k} ∈ Out ( {V}_{j} )} {w}_{jk}} WS ( {V}_{j} )$$

wherein, WS(Vᵢ) represents the weight of a candidate keyword Vᵢ in the lexical item pattern, In(Vᵢ) represents a set of candidate keywords pointing at the candidate keyword Vᵢ in the lexical item pattern, Out(Vⱼ) represents a set of candidate keywords pointed by a candidate keyword Vⱼ in the lexical item pattern, wⱼᵢ represents the similarity between the candidate keyword Vᵢ and the candidate keyword Vⱼ, wⱼₖ represents the similarity between the candidate keyword Vⱼ and a candidate keyword Vₖ, d is a damping coefficient, and WS(Vⱼ) represents the weight of the candidate keyword Vⱼ during last iteration.

Generally speaking, if one word appears in more texts, then the contribution of the word to a certain text will be smaller, i.e., the degree of distinction of using this word to distinguish the text is smaller. Therefore, a following formula is further used in the embodiment of the present disclosure to calculate the inverse document frequency of each of the candidate keywords:

$$inverse document frequency = log ( \frac{Preset amount of the documents of corpus}{\begin{matrix}Number of the documents \\ containing the candidate keywords\end{matrix} + 1} )$$

If one word is more common, then the denominator is larger, so that the inverse document frequency is smaller and is closer to 0. To add 1 for the denominator is to avoid that the denominator is 0 (i.e., none of the texts include the word). log represents to perform logarithm on the acquired value, which may reduce the numerical value that is finally acquired.

In step 140: the criticality of the candidate keywords is acquired according to the weights and the inverse document frequencies of the candidate keywords, and keywords are selected according to the criticality of the candidate keywords.

Specifically, the embodiment of the present disclosure uses the product of the weights of the candidate keywords and the inverse document frequencies of the candidate keywords as the criticality of the candidate keywords, and selects keywords according to the sequence of the criticality of each of the candidate keywords and a preset number of keywords.

In the embodiment of the present disclosure, one corresponding criticality will be finally acquired for each candidate keyword, and the candidate keywords are ordered according to the corresponding criticality in a descending order; if N keywords need to be extracted, then it is only desirable to select N candidate keywords from the candidate keyword having the highest criticality.

In the embodiment of the present disclosure, criticality=weight*inverse document frequency, wherein the calculation process of the weight is combined with the similarity between the words; meanwhile, in view of the positional relationship of the words, the contribution of the words to the text is also considered for the inverse document frequency. Such a comprehensive keyword extraction method remarkably improves the keyword extraction results.

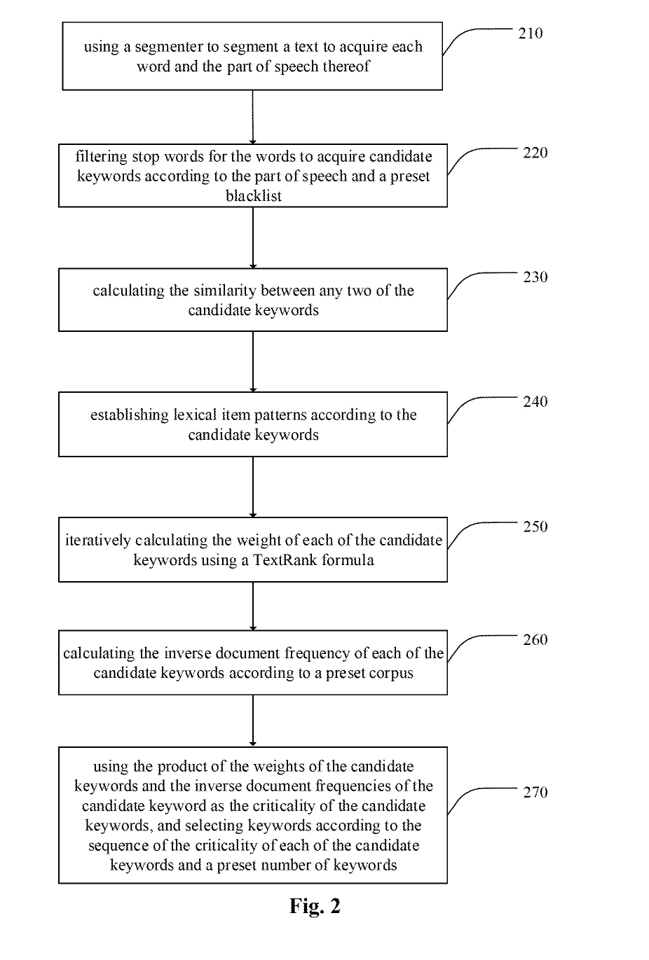

FIG. 2 is a technical flow chart of the second embodiment of the present disclosure. With reference to FIG. 2, the keyword extraction method according to the embodiment of the present disclosure may further be detailed as the following steps.

In step 210: a segmenter is used to segment a text to acquire each word and the part of speech thereof.

In the embodiment of the present disclosure, a present segmenting method used to segment the text into words may be any one or a combination of several of the following methods.

A segmenter based on dictionary matching algorithm uses dictionary matching, Chinese lexicon or other Chinese language knowledge to segment, for instance: a maximum matching method, a minimum segmenting method, or the like. While a segmenter based on lexicon matching is based on the statistics information of characters and words, for example, information between adjacent characters, term frequency and corresponding co-occurrence information are applied to segment words. Because the information is acquired by investigating true corpora, the segmenting method based on statistics has better practical applicability.

A segmenting method based on dictionary and lexicon matching matches a Chinese character string to be analyzed with entries in a sufficient big machine dictionary according to a certain strategy; if a certain character string is found in the dictionary, then the matching is successful. One word is recognized, wherein the matching is divided into forward matching and reverse matching according to the different scanning directions. According to the prior matching situations of different lengths, the matching includes maximum (longest) matching and minimum (shortest) matching. The segmenting method may also be divided into a simplex segmenting method and an integrated method combining segmenting with labeling based on that whether the matching process is combined with a process of labeling the part of speech.

Wherein, the maximum matching method (MaximumMatchingMethod) is usually referred to as an MM method. The basic thought thereof is: it is supposed that the longest word in a segmenting dictionary has i Chinese characters, then the i characters in the front of the current character string of the text processed are used as a matching field to look up the dictionary. If such an i character exists in the dictionary, then the matching is successful, and the matching filed is segmented out as a word. If such an i character cannot be found in the field, then the matching is failed, and the last character in the matching field is removed, and the remaining character string is matched again . . . the operation is continued in this manner until the matching is successful, i.e., until one word is segmented out or the length of the remaining character string is zero. One round of matching is completed in this way, and then next i character string is taken for matching until the text is completely scanned.

A reverse maximum matching method (ReverseMaximumMatchingMethod) is usually referred to as an RMM method. The basic principle of the RMM method is the same as that of the MM method, while the segmenting direction is different from that of the MM method, and a segmenting dictionary used is different as well. The reverse maximum matching method starts matching scanning from the tail end of the processed text, and 2i characters (i character string) at the tail end are taken as a matching field in each time; if the matching is failed, then the first one character of the matching field is removed to match continuously. Accordingly, a segmenting dictionary used in the method is a reverse dictionary, wherein each entry in the dictionary will be saved in a reverse order. During actual processing, the text is inverted firstly to generate a reverse text. Then the reverse text is processed using the forward maximum matching method according to the reverse lexicon.

The maximum matching algorithm is a mechanical segmenting method based on a segmenting dictionary, which cannot segment words according to the semantic features of the contents of the text, and heavily depends on the dictionary. Therefore, during practical application, some segmenting errors are unavoidable. In order to improve the accuracy of system segmenting, a segmenting solution integrating the forward maximum matching method and the reverse maximum matching method, i.e., a bilateral matching method may be adopted.

The bilateral matching method integrates the forward maximum matching method with the reverse maximum matching method. The text is grossly segmented according to punctuations to dissolve the text into a plurality of sentences, then these sentences are scanned and segmented using the forward maximum matching method and the reverse maximum matching method. If the matching results acquired through the two segmenting methods are the same, then the segmenting is considered to be correct; otherwise, it is processed according to a minimum set.

The segmenting method based on term frequency statistics is an omni-segmenting method. This method does not depend on a dictionary, but counts the frequency of any two characters appeared simultaneously in an article, and the characters with the highest frequency may possibly be a word. According to the method, all probable words matched with a vocabulary are segmented firstly, and then an optimum segmenting result is determined using a statistical language model and a decision algorithm. The advantages of the method are that all segmenting ambiguities can be found and new words are easily extracted.

A segmenting method based on knowledge understanding mainly defines words through analyzing the information provided by the context contents based on syntactic and syntactical analysis and combined with semantic analysis, and usually includes three parts: a segmenting subsystem, a syntactic and semantic subsystem and a general control part. Under the coordination of the general control part, the segmenting subsystem may acquire the syntactic and semantic information of related words and sentences to determine the segmenting ambiguities. This method tries to enable a machine to have a human understanding ability, and needs to use a large number of language knowledge and information. It is difficult to organize various language information into a form that is directly readable for the machine due to the generality and complexity of the Chinese language knowledge.

Optionally, the embodiment of the present disclosure pre-uses a regular expression to perform deduplication and denoising processing on the text before segmenting the text using a segmenter, for example, expression signs like O(∩_∩)O or highly repeated punctuations similar to “∘ ∘ ∘ ∘ ∘ ∘ ∘” or highly repeated words like “ha-ha-ha-ha-ha” in the text. An automatic reviewing template may be further counted for some specific webpage review data, for example, automatic reviews and some website links included in the review data may be removed according to the automatic reviewing template.

In step 220: stop words are filtered for the words to acquire candidate keywords according to the part of speech and a preset blacklist.

The text usually includes a large number of some words without any practical meanings such as modal particles and auxiliary words, while these words are called as stop words, and the frequencies of occurrence of these stop words are usually very high and will affect the keyword extraction accuracy if these stop words are not filtered. In the embodiment of the present disclosure, the candidate keywords are filtered firstly according to the part of speech. Generally speaking, various auxiliary words and prepositions need to be filtered. In addition, a blacklist needs to be pre-established, wherein the blacklist not only includes the stop words, but also includes some illegal vocabularies, advertising vocabularies, etc. The regular expression may be used again to clear the candidate keywords according to the pre-established blacklist to lighten the subsequent calculation pressure.

In step 230: the similarity between any two of the candidate keywords is calculated.

In the embodiment of the present disclosure, word2vec is used to convert each of the candidate keywords into a form of word vectors, and acquire the similarity between any two of the candidate keywords according to the similarity of the word vectors corresponding to each of the candidate keywords in space.

A first step to convert a natural language understanding problem into a machine learning problem is to seek a method to mathematize these signs certainly. word2vec is an effective open source tool of Google in the middle of 2013 for characterizing words into real-value vectors, using two models including a CBOW (Continuous Bag-Of-Words, i.e., continuous bag-of-words model) and a Skip-Grain model. word2vec follows Apache Open Source License 2.0, which may simplify the processing of text contents into a vector operation in a K-dimension vector space through training, while the similarity in the vector space may be used for representing the semantic similarity of the text. Therefore the word vectors outputted by word2vec may be used for performing a lot of NLP related jobs, for instance, clustering, finding synonyms and analyzing the part of speech, etc.

To calculate the similarity of the words herein is helpful for classifying the text and understanding the subject of the document, so as to improve the keyword extraction accuracy.

In the embodiment of the present disclosure, the word2vec tool is mainly used to convert the candidate keywords into the vector operation in the K-dimension vector space, and then the similarity of the word vectors in the space corresponding to each of the candidate keywords is used to calculate the corresponding similarity of each of the candidate keywords.

In step 240: lexical item patterns are established according to the candidate keywords.

A preset window is used to move on the candidate keywords one by one to select and acquire N−K+1 candidate keyword windows, and each of the windows include K adjacent candidate keywords, wherein N is the total number of the candidate keywords, and K is the size of the window.

For example, the candidate keywords are v1, v2, v3, v4, v5, . . . , vn, and the length of the window is K, then the window is covered on the candidate keywords to move one by one, and the following candidate keyword windows will be obtained: v1, v2, . . . , vk, v2, v3, . . . , vk+1, v3, v4, . . . , vk+2 . . . , etc. Based on the adjacent positional relationship, the candidate keywords in each window are mutually associated, and the windows are independent by default.

After the candidate keyword windows are acquired, an un-oriented edge is used to connect any two of the candidate keywords in each of the windows to acquire a certain number of lexical item patterns G(V, E), wherein V is a set of the candidate keywords, E is the sum of a set of edges formed by connecting any two candidate keywords, and E⊂V×V. In the lexical item patterns, each of the candidate keywords can be deemed as one node, and the lexical item pattern is namely composed of connecting lines among a plurality of nodes and nodes, and these connecting lines are powerless and un-oriented edges initially.

It should be illustrated that there is no order of sequence between step 230 and step 240, and the lexical item patterns may be established firstly and then the similarity between the candidate keywords is calculated.

In step 250: the weight of each of the candidate keywords is iteratively calculated using a TextRank formula.

When calculating the weight of each of the candidate keywords, a following formula needs to be adopted for iteratively calculating the weight of each of the candidate keywords with reference to the connecting relationship of each of the candidate keywords between the lexical item patterns and the similarity between each of the candidate keywords further:

$$WS ( {V}_{i} ) = ( 1 - d ) + d * {\sum }_{{V}_{j} ∈ In ( {V}_{i} )} \frac{{w}_{ji}}{{\sum }_{{v}_{k} ∈ Out ( {V}_{j} )} {w}_{jk}} WS ( {V}_{j} )$$

wherein, WS(Vᵢ) represents the weight of a candidate keyword Vᵢ in the lexical item pattern, In(Vᵢ) represents a set of candidate keywords pointing at the candidate keyword Vᵢ in the lexical item pattern, Out(Vⱼ) represents a set of candidate keywords pointed by a candidate keyword Vⱼ in the lexical item pattern, wⱼᵢ represents the similarity between the candidate keyword Vᵢ and the candidate keyword Vⱼ, wⱼₖ represents the similarity between the candidate keyword Vⱼ and a candidate keyword Vₖ, d is a damping coefficient, and WS(Vⱼ) represents the weight of the candidate keyword Vⱼ during last iteration.

In the embodiment of the present disclosure, the iteration times is a preset empirical value, and the iteration times is influenced by the initial value of the weight of the candidate keyword. Usually, it is desirable to assign an initial value for any appointed candidate keyword in the lexical item pattern. In the embodiment of the present disclosure, the initial value of the weight of each of the candidate keywords is set as 1.

In order to avoid endless loop iteration during the weight calculating process, the upper limit of the iteration times is set for the iterative process in the embodiment of the present disclosure. The iteration times is set as 200 according to the empirical value, i.e., when the iteration times reaches 200, the iterative process is stopped, and the acquired result is used as the weight score of the corresponding candidate keyword.

Optionally, the embodiment of the present disclosure may also determine the iteration times through determining whether the iteration result is converged. When the iteration result is converged, the iteration may be stopped immediately, and the appointed candidate keyword will acquire a weight value. A point of convergence for the convergence herein can be reached by determining whether the error rate of the calculated weight value of the appointed candidate keyword is less than a preset limit value. The error rate of the candidate keyword Vi is the difference between the actual weight thereof and the weight acquired during the K iteration. However, because the actual weight of the candidate keyword is unknown, the error rate is approximately deemed as the difference of the candidate keyword between two iteration results, and the limit value is 0.0001 generally.

The lexical item patterns will change after repeatedly iterative calculations.

In step 260: the inverse document frequency of each of the candidate keywords is calculated according to a preset corpus.

$$inverse document frequency = log ( \frac{Preset amount of the documents of corpus}{\begin{matrix}Number of the documents \\ containing the candidate keywords\end{matrix} + 1} )$$

It should be illustrated that there is no order of sequence between step 250 and step 260. In the embodiment of the present disclosure, the inverse document frequency may be calculated firstly, and then the weight of each candidate keyword is iteratively calculated, which will not be limited by the present disclosure.

In step 270: the product of the weights of the candidate keywords and the inverse document frequencies of the candidate keywords is used as the criticality of the candidate keywords, and keywords are selected according to the sequence of the criticality of each of the candidate keywords and a preset number of keywords.

Criticality of Vᵢ=IDF*WS(Vᵢ)

In the keyword extraction algorithm according to the embodiment, data redundancy is lightened and the calculation efficiency during the keyword extraction process is improved through further filtering unessential factors in the text; meanwhile, the word2vec tool is used to determine synonyms, and the quality and accuracy of the keywords extracted are higher with reference to the positional relationship and term frequency of the words.

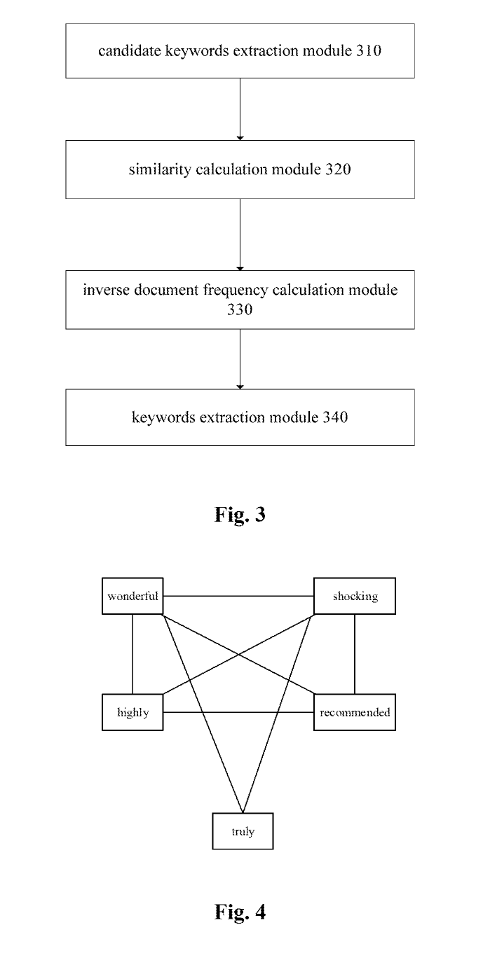

FIG. 3 is a technical flow chart of the third embodiment of the present disclosure. With reference to FIG. 3, the keyword extraction device of the present disclosure mainly includes a candidate keywords acquisition module 310, a similarity calculation module 320, an inverse document frequency calculation module 330 and a keyword extraction module 340.

The candidate keyword acquisition module 310 is configured to use a segmenter to segment a text to acquire each word and the part of speech thereof, and filter stop words for the words to acquire candidate keywords according to the part of speech and a preset blacklist.

The similarity calculation module 320 is configured to calculate the similarity between any two of the candidate keywords.

The inverse document frequency calculation module 330 is configured to iteratively calculate the weight of each of the candidate keywords using a TextRank formula according to the similarity, and calculate the inverse document frequency of each of the candidate keywords according to a preset corpus.

The keyword extraction module 340 is configured to use the product of the weights of the candidate keywords and the inverse document frequencies of the candidate keywords as the criticality of the candidate keywords, and select keywords according to the sequence of the criticality of each of the candidate keywords and a preset number of keywords.

Further, the similarity calculation module 320 is further configured to: use word2vec to convert each of the candidate keywords into a form of word vectors, and acquire the similarity between any two of the candidate keywords according to the similarity of the word vectors corresponding to each of the candidate keywords in space.

The device further includes a patterning module 350, wherein the patterning module 350 is configured to use a preset window to move on the candidate keywords one by one to select and acquire N−K+1 candidate keyword windows before the iteratively calculating the weight of each of the candidate keywords using the TextRank formula according to the similarity, each of the windows includes K adjacent candidate keywords, wherein N is the total number of the candidate keywords, and K is the size of the window; and use an un-oriented edge to connect any two of the candidate keywords in each of the windows to acquire a certain number of lexical item patterns G(V, E), wherein V is a set of the candidate keywords, E is the sum of a set of edges formed by connecting any two candidate keywords, and E⊂V×V.

The inverse document frequency calculation module 330 is further configured to: use a following formula to iteratively calculate the weight of each of the candidate keywords according to preset iteration times:

$$WS ( {V}_{i} ) = ( 1 - d ) + d * {\sum }_{{V}_{j} ∈ In ( {V}_{i} )} \frac{{w}_{ji}}{{\sum }_{{v}_{k} ∈ Out ( {V}_{j} )} {w}_{jk}} WS ( {V}_{j} )$$

wherein, WS(Vᵢ) represents the weight of a candidate keyword Vᵢ in the lexical item pattern, In(Vᵢ) represents a set of candidate keywords pointing at the candidate keyword Vᵢ in the lexical item pattern, Out(Vⱼ) represents a set of candidate keywords pointed by a candidate keyword Vⱼ in the lexical item pattern, wⱼᵢ represents the similarity between the candidate keyword Vᵢ and the candidate keyword Vⱼ, wⱼₖ represents the similarity between the candidate keyword Vⱼ and a candidate keyword Vₖ, d is a damping coefficient, and WS(Vⱼ) represents the weight of the candidate keyword Vⱼ during last iteration.

The inverse document frequency calculation module 330 is further configured to: use a following formulate to calculate the inverse document frequency of each of the candidate keywords:

$$inverse document frequency = log ( \frac{Preset amount of the documents of corpus}{\begin{matrix}Number of the documents \\ containing the candidate keywords\end{matrix} + 1} )$$

wherein, log( ) represents a logarithm operation.

It is provided that a web crawler crawls a text of Douban film review for keyword extraction processing, and the contents of the text are as follows: Ha-ha-ha-ha-ha-ha-ha! Too wonderful ̂_̂! Too shocking! Highly recommend! This is a film capable of making people laugh truly and be choked up and moved - - - good comedy scripts and performers, which is more difficult to show well than a tragedy actually, the show of the two lead performers are quite outstanding, and the details are also very brilliant and in place. It is really memorable ∘ ∘ ∘ ∘ ∘ ∘ a recommended address for downloading is http://movie.xxx.com.

In order to extract the keywords thereof of such a film review as labels, a regular expression is used to perform deduplication and denoising processing on the text before segmenting terms, to remove such unessential contents like “ha-ha ha-ha ha-ha ha”, “̂_̂”, “ - - - ”, “∘ ∘ ∘ ∘ ∘ ∘ ”, “∘ ∘ ∘ ∘ ∘ ∘ ”, “http://movie.xxx.com”, so that the text is cleaner.

Therefore, the following results are obtained.

! Too wonderful! Too shocking! Highly recommend! This is a film capable of making people laugh truly and be choked up and moved good comedy scripts and performers, which is more difficult to show well than a tragedy actually, the show of the two lead performers are quite outstanding, and the details are also very brilliant and in place. It is really memorable a recommended address for downloading.

In this segment of text, there are multiple punctuation marks and stop words excluding necessary sentences. At this moment, a regular expression may be used to filter out the punctuation marks and those words like “too, this, is, can”, or the like, to obtain the following results:

Wonderful shocking highly recommend film capable of making people laugh truly and be choked up and moved with good comedy scripts and performers which is more difficult to show well than a tragedy actually the show of the two lead performers are quite outstanding and the details are also very brilliant and in place it is really memorable a recommended address for downloading

Next, the sentences are segmented using a segmenter, wherein a word segmenting method based on dictionary and lexicon matching is employed at this moment, to forwards scan each word, and match the word with a preset lexicon, wherein the following results may be obtained.

Wonderful shocking highly recommend making people laugh truly and choked up moved film good comedy scripts performers which is than tragedy more difficult show well two lead performer of show quite “outstanding and the details also very brilliant in place memorable recommended downloading address

After segmented keywords are acquired, it is found that some individual characters cannot form a word and do not have practical meanings. Therefore, it is also desirable to further filter to remove the individual characters which cannot form a word. Further, a word2vec tool is used to convert the plurality of acquired candidate keywords into word vectors and calculate the similarity W between any of the two candidate keywords, for example: W (wonderful, shocking)=a, W (wonderful, highly)=b, and W (wonderful, recommended)=c, or the like. Meanwhile, a window with a length of 5 is used to cover the candidate keywords and move on the candidate keywords one by one to obtain the following candidate keyword windows:

wonderful shocking highly recommended truly

shocking highly recommended truly laugh

highly recommended truly laugh choke up

recommended truly laugh choke up moved

truly laugh choke up moved film

laugh choke up moved film good

. . .

memorable recommended downloading address

The words in each window are interconnected, and every two are mutually pointed to, which are as shown in FIG. 4.

A pointing relationship and the similarity W after being acquired are substituted into the TextRank formula to calculate the weight of each candidate keyword.

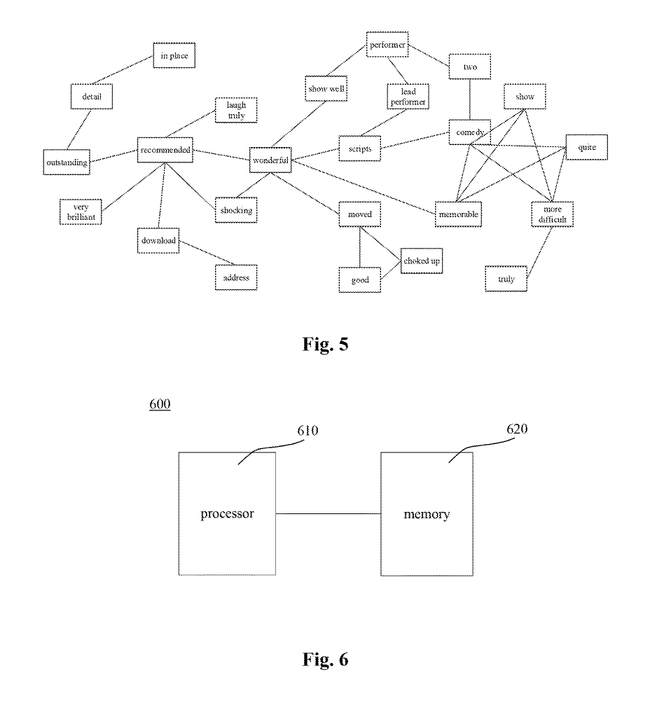

It is provided that the result of FIG. 5 is acquired after iteration for 200 times. The voting results of the keyword may be acquired from FIG. 5, wherein the corresponding weight of the candidate keyword which is mostly pointed to, is the highest. Meanwhile, for each candidate keyword, the inverse document frequency of each of the candidate keywords also needs to be calculated with reference to the preset corpus. The product of the weight and the inverse document frequency is the corresponding criticality of each candidate keyword. These candidate keywords are arranged according to the corresponding criticality in a descending order, and may be extracted according to a needed number.

FIG. 6 is a schematic view of an n electronic device according to one embodiment of the present disclosure. The n electronic device 600 includes:

a processor 610; and

a memory 620 for storing instructions executable by the processor 610;

wherein the processor 610 is configured to:

use a segmenter to segment a text to acquire words, and filter the words to acquire candidate keywords;

calculate the similarity between any two of the candidate keywords;

calculate the weights of the candidate keywords according to the similarity, and calculate the inverse document frequencies of the candidate keywords according to a preset corpus; and

acquire the criticality of the candidate keywords according to the weights and the inverse document frequencies of the candidate keywords, and select keywords according to the criticality of the candidate keywords.

In exemplary embodiments, there is also provided a non-transitory computer-readable storage medium including instructions, such as included in the memory 620, executable by the processor 610 in the electronic device 600, for performing any of the above-described keyword extraction method.

In exemplary embodiments, the electronic device 600 may be various handheld terminals, such as a mobile phone, a personal digital assistant (PDA), etc.

In exemplary embodiments, the non-transitory computer-readable storage medium may be a read-only memory (ROM), a programmable ROM (PROM), an electrically programmable ROM (EPROM), an electrically erasable programmable ROM (EEPROM), a flash memory, a random access memory (RAM) which can act as an external cache memory. As an example and not restrictive, RAM may be obtained in various forms, such as a synchronous RAM (DRAM), a dynamic RAM (DRAM), a synchronous DRAM (SDRAM), a double data rate SDRAM (DDR SDRAM), an enhanced SDRAM (ESDRAM), a synchronization link DRAM (SLDRAM), and a direct RambusRAM (DRRAM). The computer-readable storage medium in the present disclosure are intended to include, but not limited to, these and any other suitable types of memory. The computer-readable storage medium may also be a compression disk (CD), a laser disc, an optical disk, a digital versatile disc (DVD), a floppy disks, a blue-ray disk, etc.

The various illustrative logical blocks, modules and circuits described in combination with the contents disclosed herein may be realized or executed by the following components which are designed for performing the above methods: a general purpose processor, a digital signal processor (DSP), an application specific integrated circuit (ASIC), a field programmable gate array (FPGA), or other programmable logic devices, a discrete gate, or a transistor logic, a discrete hardware element or any combination thereof. The general purpose processor may be a microprocessor. Alternatively, the processor may be any conventional processor, controller, microcontroller or state machine. The processor may also be implemented as a combination of the computing devices, such as a combination of a DSP and a microprocessor, a plurality of microprocessors, one or more microprocessor combined with a DSP core, or any other such configurations.

One of ordinary skill in the art will understand that the above described modules can each be implemented by hardware, or software, a combination of hardware and software. One of ordinary skill in the art will also understand that multiple ones of the above described modules may be combined as one module, and each of the above described modules may be further divided into a plurality of sub-modules.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A keyword extraction method, comprising:
using a segmenter to segment a text to acquire words, and filtering the words to acquire candidate keywords;
calculating the similarity between any two of the candidate keywords;
calculating the weights of the candidate keywords according to the similarity, and calculating the inverse document frequencies of the candidate keywords according to a preset corpus; and
acquiring the criticality of the candidate keywords according to the weights and the inverse document frequencies of the candidate keywords, and selecting keywords according to the criticality of the candidate keywords.

2. The method according to claim 1, wherein calculating the similarity between any two of the candidate keywords comprises:
using word2vec to convert the candidate keywords into a form of word vectors, and acquiring the similarity between any two of the candidate keywords according to the similarity of the word vectors of the candidate keywords in space.

3. The method according to claim 1, wherein calculating the weights of the candidate keywords comprises:
using a preset window to move on the candidate keywords one by one to select and acquire N−K+1 candidate keyword windows, each of the windows comprises K adjacent candidate keywords, wherein N is the total number of the candidate keywords, and K is the size of the window;
using an un-oriented edge to connect any two of the candidate keywords in each of the windows to acquire a certain number of lexical item patterns G(V, E), wherein V is a set of the candidate keywords, E is the sum of a set of edges formed by connecting any two candidate keywords, and E⊂V*V;
using a following formula to iteratively calculate the weight of each of the candidate keywords according to preset iteration times:
$$WS ( {V}_{i} ) = ( 1 - d ) + d * {\sum }_{{V}_{j} ∈ In ( {V}_{i} )} \frac{{w}_{ji}}{{\sum }_{{v}_{k} ∈ Out ( {V}_{j} )} {w}_{jk}} WS ( {V}_{j} )$$
wherein, WS(Vᵢ) represents the weight of a candidate keyword Vᵢ in the lexical item pattern, In(Vᵢ) represents a set of candidate keywords pointing at the candidate keyword Vᵢ in the lexical item pattern, Out(Vⱼ) represents a set of candidate keywords pointed by a candidate keyword Vⱼ in the lexical item pattern, wⱼᵢ represents the similarity between the candidate keyword Vᵢ and the candidate keyword Vⱼ, wⱼₖ represents the similarity between the candidate keyword Vⱼ and a candidate keyword Vₖ, d is a damping coefficient, and WS(Vⱼ) represents the weight of the candidate keyword Vⱼ during last iteration.

4. The method according to claim 1, wherein the calculating the inverse document frequencies of each of the candidate keywords according to the preset corpus comprises:
using a following formulate to calculate the inverse document frequency of each of the candidate keywords:
$$inverse document frequency = log ( \frac{Preset amount of the documents of corpus}{\begin{matrix}Number of the documents \\ containing the candidate keywords\end{matrix} + 1} )$$
wherein, log( ) represents a logarithm operation.

5. The method according to claim 1, wherein the acquiring the criticality of the candidate keywords according to the weights and the inverse document frequencies of the candidate keywords comprises:
using the product of the weights of the candidate keywords and the inverse document frequencies of the candidate keywords as the criticality of the candidate keywords, and selecting keywords according to the sequence of the criticality of each of the candidate keywords and a preset number of keywords.

6. An electronic device, comprising:
a processor; and
a memory for storing instructions executable by the processor;
wherein the processor is configured to:
use a segmenter to segment a text to acquire words, and filter the words to acquire candidate keywords;
calculate the similarity between any two of the candidate keywords;
calculate the weights of the candidate keywords according to the similarity, and calculate the inverse document frequencies of the candidate keywords according to a preset corpus; and
acquire the criticality of the candidate keywords according to the weights and the inverse document frequencies of the candidate keywords, and select keywords according to the criticality of the candidate keywords.

7. The electronic device according to claim 6, wherein the processor is further configured to:
use word2vec to convert the candidate keywords into a form of word vectors, and acquire the similarity between any two of the candidate keywords according to the similarity of the word vectors of the candidate keywords in space.

8. The electronic device according to claim 6, wherein the processor is further configured to:
use a preset window to move on the candidate keywords one by one to select and acquire N−K+1 candidate keyword windows, each of the windows comprises K adjacent candidate keywords, wherein N is the total number of the candidate keywords, and K is the size of the window;
use an un-oriented edge to connect any two of the candidate keywords in each of the windows to acquire a certain number of lexical item patterns G(V, E), wherein V is a set of the candidate keywords, E is the sum of a set of edges formed by connecting any two candidate keywords, and E⊂V*V;
use a following formula to iteratively calculate the weight of each of the candidate keywords according to preset iteration times:
$$WS ( {V}_{i} ) = ( 1 - d ) + d * {\sum }_{{V}_{j} ∈ In ( {V}_{i} )} \frac{{w}_{ji}}{{\sum }_{{v}_{k} ∈ Out ( {V}_{j} )} {w}_{jk}} WS ( {V}_{j} )$$
wherein, WS(Vᵢ) represents the weight of a candidate keyword Vᵢ in the lexical item pattern, In(Vᵢ) represents a set of candidate keywords pointing at the candidate keyword Vᵢ in the lexical item pattern, Out(Vⱼ) represents a set of candidate keywords pointed by a candidate keyword Vⱼ in the lexical item pattern, wⱼᵢ represents the similarity between the candidate keyword Vᵢ and the candidate keyword Vⱼ, wⱼₖ represents the similarity between the candidate keyword Vⱼ and a candidate keyword Vₖ, d is a damping coefficient, and WS(Vⱼ) represents the weight of the candidate keyword Vⱼ during last iteration.

9. The electronic device according to claim 6, wherein the processor is further configured to:
use a following formulate to calculate the inverse document frequency of each of the candidate keywords:
$$inverse document frequency = log ( \frac{Preset amount of the documents of corpus}{\begin{matrix}Number of the documents \\ containing the candidate keywords\end{matrix} + 1} )$$
wherein, log( ) represents a logarithm operation.

10. The electronic device according to claim 6, wherein the processor is further configured to:
use the product of the weights of the candidate keywords and the inverse document frequencies of the candidate keywords as the criticality of the candidate keywords, and select keywords according to the sequence of the criticality of each of the candidate keywords and a preset number of keywords.

11. A non-transitory computer-readable storage medium having stored therein instructions that, when executed by one or more processors of an electronic device, cause the electronic device to perform operations including:
using a segmenter to segment a text to acquire words, and filtering the words to acquire candidate keywords;
calculating the similarity between any two of the candidate keywords;
calculating the weights of the candidate keywords according to the similarity, and calculating the inverse document frequencies of the candidate keywords according to a preset corpus; and
acquiring the criticality of the candidate keywords according to the weights and the inverse document frequencies of the candidate keywords, and selecting keywords according to the criticality of the candidate keywords.
